(19) United States
(12) Patent Application Publication
(10) Pub. No.: US 2011/0266463 A1
(43) Pub. Date: Nov. 3, 2011

(54) Partitioned cavity

(76) Inventors: Pinchas Einziger, Haifa (IL); Denis Dikarov, Kfar Saba (IL); Yoel Biberman, Haifa (IL)

(21) Appl. No.: 13/067,019

(22) Filed: May 3, 2011

Related U.S. Application Data
(60) Provisional application No. 61/282,982, filed on May 3, 2010.

(51) Int. Cl. G21K 5/00

(52) U.S. Cl. 250/492.1

(57) ABSTRACT

Apparatuses and methods may include a source of electromagnetic energy configured to deliver electromagnetic energy to an energy application zone and to apply electromagnetic energy to an object. The energy application zone may be divided into subzones by at least one partition comprising an electromagnetic field disruptive material. The source may be configured to deliver electromagnetic energy to multiple subzones by supplying electric fields transverse to the at least one partition.

The present application claims priority to U.S. Provisional Patent Application No. 61/282,982, which was filed on May 3, 2010, and which is fully incorporated herein by reference.

### TECHNICAL FIELD

This application relates to apparatuses and methods for applying electromagnetic energy to objects.

### BACKGROUND

Electromagnetic waves are commonly used to apply energy to objects. Typically, such objects are located in a cavity configured to receive electromagnetic energy. One example of an electromagnetic energy application device is a microwave oven. In a microwave oven, microwaves are used to transfer electromagnetic energy from an energy source to the object through air. The electromagnetic energy is then absorbed by the object and converted to thermal energy, causing the temperature of the object to rise. In order to increase the load capacity of an oven, partition structures may be used to divide the space inside the oven into multiple subzones. While such partition structures may be effective in establishing such subzones, the introduction of the partition structures may affect the electrical field distribution inside the oven, resulting in a more complicated control of heating process. In addition, these partitions may create subzones as standalone resonators, in which the electric field may become isolated within the resonators and cannot reach outside of the resonators.

### SUMMARY

Some exemplary aspects of the invention may be directed to an apparatus for applying electromagnetic energy to an object. The apparatus may include a source of electromagnetic energy and an energy application zone. The energy application zone may be dividable into subzones by at least one partition. The partition may include an electromagnetic field disruptive material. A source may be configured to deliver electromagnetic energy to multiple subzones by supplying electric fields transverse to the at least one partition.

The preceding summary is not intended to restrict in any way the scope of the claimed invention. In addition, it is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate various embodiments and exemplary aspects of the present invention and, together with the description, explain principles of the invention. In the drawings:

FIG. 1 is a schematic diagram of an apparatus for applying electromagnetic energy to an object in a cavity, in accordance with some exemplary embodiments of the present invention;

FIGS. 2A-2D provide diagrammatic representations of partitioned cavities, in accordance with some exemplary disclosed embodiments; and

FIGS. 3A-3G illustrate partition configurations consistent with exemplary disclosed embodiments.

### DESCRIPTION OF EXEMPLARY EMBODIMENTS

Reference will now be made in detail to exemplary embodiments of the invention, examples of which are illustrated in the accompanying drawings. When appropriate, the same reference numbers are used throughout the drawings to refer to the same or like parts.

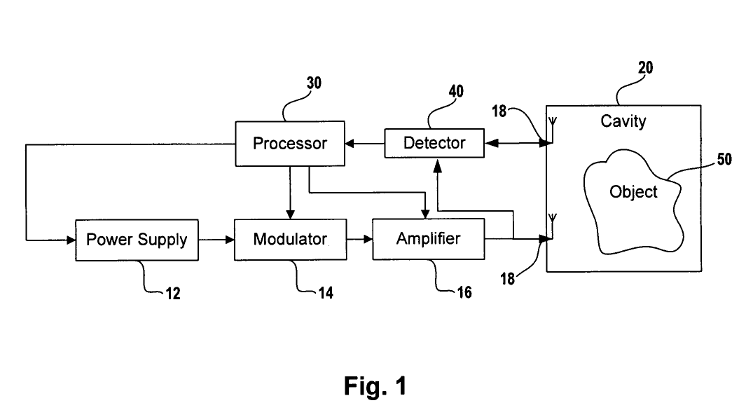

In one respect, the invention may involve apparatuses and methods for applying electromagnetic energy to an object in an energy application zone. As used herein, the term apparatus may include any component or group of components described herein. For example, an apparatus may refer only to a processor, such as processor 30, as illustrated in FIG. 1. Alternatively, an apparatus may include a combination of a processor and one or more radiating elements; a processor, a cavity, and one or more radiating elements; a processor and a source of electromagnetic energy; a processor, a cavity, one or more radiating elements, and a source of electromagnetic energy; or any other combination of components described herein.

The term electromagnetic energy, as used herein, includes any or all portions of the electromagnetic spectrum, including but not limited to, radio frequency (RF), infrared (IR), near infrared, visible light, ultraviolet, etc. In some cases, applied electromagnetic energy may include RF energy with a wavelength of 100 km to 1 mm and a frequency of 3 KHz to 300 GHz. In some cases, RF energy within a narrower frequency range, e.g., 1 MHz-100 GHz, may be applied. Microwave and ultra high frequency (UHF) energy, for example, are both within the RF range. Even though examples of the invention are described herein in connection with the application of RF energy, these descriptions are provided to illustrate a few exemplary principles of the invention, and are not intended to limit the invention to any particular portion of the electromagnetic spectrum.

Similarly, for exemplary purposes, this disclosure contains a number of examples of electromagnetic energy used for heating. Again, these descriptions are provided to illustrate exemplary principles of the invention. The invention, as described and claimed, may benefit various products and industrial, commercial, and consumer processes involving the application of energy, regardless of whether the application of energy results in a temperature rise. For example, electromagnetic energy may be applied to an object for heating, combusting, thawing, defrosting, cooking, drying, accelerating reactions, expanding, evaporating, fusing, causing or altering biologic processes, medical treatments, sintering, heat treatment of various materials, preventing freezing or cooling, maintaining the object within a desired temperature range, or any other application where it may be desirable to apply energy.

Moreover, reference to an object (or load) to which electromagnetic energy may be applied is not limited to a particular form. An object may include a liquid, solid, or gas, depending upon the particular process with which the invention may be utilized, and the object may include composites or mixtures of matter in one or more differing phases. Further, although the term object is in the singular, it may refer to multiple items or detached parts or components. Thus, by way of non-limiting example, the term object may encompass such matter as food to be thawed or cooked; clothes or other material to be dried; frozen material (e.g., organs) to be thawed; chemicals to be reacted; fuel or other combustible material to be to be combusted; hydrated material to be dehydrated; gases to be expanded; liquids to be thawed, heated, boiled or vaporized; blood or blood components (e.g., blood plasma or red blood cells) to be thawed and/or warmed; materials to be manufactured; components to be connected; polymers to be cured, compacted powders to be sintered, semi-conductive wafers to be heat treated, or any other material for which there is a desire to even nominally apply electromagnetic energy.

In accordance with the invention, an apparatus or method may further involve the use of an energy application zone. An energy application zone may include any void, location, region, or area where electromagnetic energy may be applied. It may include a hollow, or may be filled or partially filled with liquids, solids, gases, or combinations thereof. By way of example only, an energy application zone may include the interior of an enclosure, interior of a partial enclosure (e.g., a conveyor belt oven), interior of a conduit, open space, solid, or partial solid, which allows for the existence, propagation, evanescent and/or resonance of electromagnetic waves. The zone may be permanent or may be temporarily constituted for purposes of energy application. For ease of discussion, all such alternative energy application zones may alternatively be referred to as cavities, with the understanding that the term cavity implies no particular physical structure other than an area in which electromagnetic energy may be applied.

The energy application zone may be located in an oven, chamber, tank, dryer, thawer, dehydrator, reactor, engine, chemical or biological processing apparatus, incinerator, material shaping or forming apparatus, furnace, cabinet, conveyor, combustion zone, or any area where it may be desirable to apply energy. In some embodiments, the energy application zone may be part of a vending machine, in which objects are processed once purchased. Thus, consistent with some embodiments, the electromagnetic energy application zone may include an electromagnetic resonator (also known as a cavity, cavity resonator, or resonant cavity). The electromagnetic energy may be delivered to an object when the object or a portion thereof is located in the energy application zone.

An energy application zone may have a predetermined configuration or a configuration that is otherwise determinable. The energy application zone may assume any shape that permits electromagnetic wave propagation inside the energy application zone. For example, all or part of the energy application zone may have a cross-section that may be spherical, hemispherical, rectangular, toroidal, circular, triangular, oval, pentagonal, hexagonal, octagonal, elliptical, or any other shape or combination of suitable shapes. It is also contemplated that the energy application zone may be closed, e.g., completely enclosed by conductor materials, bounded at least partially, or open, e.g., having non-bounded openings. The general methodology of the invention is not limited to any particular cavity shape, configuration, or degree of closure. In some applications, but not all, a high degree of closure may be preferred.

In accordance with some embodiments of the invention, the energy application zone may support at least one resonant wavelength. For example, cavity 20 may be designed with dimensions permitting it to be resonant in a predetermined range of frequencies (e.g., the UHF or microwave range of frequencies, such as between 300 MHz and 3 GHz, or between 100 MHz and 1 GHZ). Depending on the intended application, the dimensions of cavity 20 may also be designed to permit resonances in other ranges of frequencies in the electromagnetic spectrum. The term “resonant” or “resonance” refers to the tendency of electromagnetic waves to oscillate in the energy application zone at larger amplitudes at some frequencies (known as “resonance frequencies”) than at others. Electromagnetic waves at a resonant frequency corresponding to a specific energy application zone may form standing waves. A standing wave is characterized by local electrical field peaks and valleys where the absolute values of the electrical field intensity are the greatest, and zeroes where the absolute values are the smallest. The absolute value of electrical field intensity may be referred to as the magnitude of the field. Electromagnetic waves resonating at a particular resonance frequency may have a corresponding “resonance wavelength” that is inversely proportional to the resonance frequency, determined via λ=c/f, where λ is the resonance wavelength, f is the resonance frequency, and c is the propagating speed of the electromagnetic waves in the energy application zone. The propagating speed may change depending on the medium through which the wave propagates through. Therefore, when the energy application zone comprises more than one material, c may not be uniquely defined. Nevertheless, the resonance wavelength may be uniquely determined using a slightly different relation, including, for example, using an estimation based on c of the major component or an average of the c of miscellaneous components, or any other technique known in the art.

Among the resonant wavelengths that are supported by the energy application zone, there may be a largest resonant wavelength. The largest resonant wavelength may be determined uniquely by the geometry of the zone. In some embodiments, the largest resonant wavelength of any given energy application zone may be determined or estimated experimentally, as known in the art, mathematically and/or by simulation. By way of example, a rectangular cavity of dimensions length a, width b, and height c may support a plurality of resonant wavelengths, the largest resonant wavelength among which is λ₀. If a>b>c, then the largest resonant wavelength λ₀ is given by

$$\frac{2 ab}{\sqrt{{a}^{2} + {b}^{2}}} .$$

By way of another example, if the energy application zone is a cubic of dimensions a×a×a, then the largest resonant wavelength is given by \sqrt{2}a. In yet another example, if the energy application zone is a cylinder of radius a and length d, then the largest resonant wavelength is given by

$$\frac{2 π a}{2.405} if 2 a > d , and \frac{2 π a}{\sqrt{{1.841}^{2} + {( \frac{π a}{d} )}^{2}}} if 2 a < d .$$

In another example, if the energy application zone is a sphere of radius a, then the largest resonant wavelength is given by

$$\frac{2 π a}{2.744} .$$

The forgoing examples are simply meant to illustrate that regardless of shape, each energy application zone may support at least one resonant wavelength.

FIG. 1 includes a diagrammatic representation of an apparatus for application of electromagnetic energy according to some exemplary embodiments. This apparatus may include an energy application zone, such as cavity 20, as represented in FIG. 1. An object 50 (e.g., an object to be processed by electromagnetic energy) may be positioned in cavity 20. Object 50 need not be located completely within the energy application zone. Object 50 may be positioned such that at least a portion of the object is located in the energy application zone. In certain embodiments, object 50 may be located completed within cavity 20.

In accordance with some embodiments, an apparatus or method may involve the use of a source configured to deliver electromagnetic energy to the energy application zone. A source may include any component or components suitable for generating and supplying electromagnetic energy. For example, electromagnetic energy may be supplied to the energy application zone in the form of electromagnetic waves at predetermined wavelengths or frequencies (also known as electromagnetic radiation). Electromagnetic waves may include propagating waves, resonating waves, evanescent waves, and/or waves that travel through a medium in any other manner. Electromagnetic radiation may carry energy that may be imparted to (or dissipated into) matter (e.g., an object) with which it interacts.

Referring to FIG. 1, the source may include a power supply 12, which includes one or more components configured to generate electromagnetic waves for carrying electromagnetic energy. For example, power supply 12 may include a magnetron configured to generate high power microwave waves at a predetermined wavelength or frequency. Alternatively, power supply 12 may include a semiconductor oscillator, such as a voltage controlled oscillator, configured to generate AC waveforms (e.g., AC voltage or current) with a constant or varying frequency. AC waveforms may include sinusoidal waves, square waves, pulsed waves, triangular waves, or another type of waveforms with alternating polarities. Alternatively, a source of electromagnetic energy may include any other power supply, such as an electromagnetic field generator, electromagnetic flux generator, or any mechanism for generating vibrating electrons.

In some embodiments, the apparatus may include at least one modulator 14 configured to modify one or more characteristics associated with the electromagnetic waves generated by power supply 12. For example, modulator 14 may be configured to modify one or more characteristics of a waveform, including amplitude (e.g., an amplitude difference between different radiating elements), phase, and/or frequency.

In some embodiments, modulator 14 may include at least one of a phase modulator, a frequency modulator, or an amplitude modulator configured to modify the phase, frequency, or amplitude of the AC waveform, respectively. In some embodiments, modulator 14 may be integrated as part of power supply 12, such that the AC waveforms generated by power supply 12 may have at least one of a modulated frequency, a varying phase, and a varying amplitude over time.

The apparatus may also include an amplifier 16 for amplifying, for example, the AC waveforms before or after they are modified by modulator 14. Amplifier 16 may include, for example, a power amplifier including one or more power transistors. Amplifier 16 may include a step-up transformer having more turns in the secondary winding than in the primary winding. In other embodiments, amplifier 16 may also include a power electronic device such as an AC-to-DC-to-AC converter. Alternatively, amplifier 16 may include any other device(s) or circuit(s) configured to scale up an input signal to a desired level.

The apparatus may also include at least one radiating element 18 configured to transmit electromagnetic energy to object 50. Radiating element 18 may include one or more waveguides and/or one or more antennas (also known as power feeds) for supplying electromagnetic energy to object 50. For example, radiating element 18 may include slot antennas. Alternatively, radiating element 18 may also include waveguides or antennas of any other kind or form, or any other suitable structure from which electromagnetic energy may be emitted.

Power supply 12, modulator 14, amplifier 16, and radiating element 18 (or portions thereof) may be separate components or any combination of them may be integrated together to form a single unit. For example, a magnetron may be included in power supply 12 to generate electromagnetic energy, and a waveguide may be physically attached to the magnetron for transmitting the energy to object 50. Alternatively, radiating element 18 may be separated from the magnetron. Similarly, other types of electromagnetic generators may be used where the radiating element is either physically separate from or part of the generator.

In some embodiments, more than one radiating element may be provided. The radiating elements may be located on one or more surfaces of the energy application zone (e.g., cavity 20). Alternatively, radiating elements 18 may be located inside or outside the energy application zone. When radiating elements 18 are located outside the zone, they may be coupled to elements that would allow the radiated energy to reach the energy application zone. The orientation and configuration of each radiating element may be distinct or the same, based on the requirements of a particular application. Furthermore, the location, orientation, and configuration of each radiating element may be predetermined before applying energy to object 50. In other embodiments, these parameters may be dynamically adjusted, e.g., using a processor, while applying energy. The invention is not limited to radiating elements having any particular structures or having any particular location with respect to an energy application zone.

In addition to supplying electromagnetic energy, radiating element 18 may also be configured to receive electromagnetic energy. In other words, as used herein, the term radiating element may broadly refer to any structure from which electromagnetic energy may radiate and/or be received, regardless of whether the structure was originally designed for the purposes of radiating or receiving energy, and regardless of whether the structure serves any additional function. Thus, an apparatus or method in accordance with the invention may involve the use of one or more detectors configured to detect signals associated with electromagnetic waves received by the one or more radiating elements. For example, as shown in FIG. 1, a detector 40 may be coupled to radiating elements 18 that, when functioning as receivers, receive electromagnetic waves from cavity 20. Additionally or alternatively, one or more sensor(s) may be used to sense information (e.g., signals) relating to object 50 and/or to the energy application process and/or the energy application zone (e.g., cavity 20).

As used herein, a detector may include one or more electric circuits configured to measure, sense, monitor, etc. at least one parameter associated with an electromagnetic wave. For example, such a detector may include a power meter configured to detect a level of power associated with an incident, reflected and/or transmitted electromagnetic wave (also known as “incident power,” “reflected power,” and “transmitted power”). Such a detector may also include an amplitude detector configured to detect an amplitude of the wave, a phase detector configured to detect a phase of the wave, a frequency detector configured to detect a frequency of the wave, and/or any other circuit suitable for detecting a characteristic of an electromagnetic wave. In certain embodiments, the source may supply incident power to a radiating element functioning as a transmitter (e.g., that radiate electromagnetic energy). In turn, this incident power may then be applied into the energy application zone (e.g., cavity 20) by the transmitter. Of the incident power, a portion may be dissipated by the object. This portion of the incident power dissipated by the object may be referred to as dissipated power (also known as “absorbed power”). The terms dissipated or dissipation are interchangeable with absorbed or absorption. Another portion of the incident power may be reflected. This portion of the incident power may be referred to as reflected power. Reflected power may include, for example, power reflected back to the transmitter via the object and/or the energy application zone. Reflected power may also include power retained by the port of the transmitter (i.e., power that is emitted by the antenna but does not flow into the zone). The rest of the incident power, other than the reflected power and dissipated power may be transmitted to one or more radiating elements functioning as receivers (e.g., those receive electromagnetic energy). This portion of the incident power may be referred to as transmitted power.

In some embodiments, the detector may include a directional coupler, configured to allow signals to flow from the amplifier to the radiating elements when the radiating elements function as transmitters, and to allow signals to flow from the radiating elements to the amplifier when the radiating elements function as receivers. Additionally, the directional coupler may be further configured to measure the power of a flowing signal. In some embodiments, the detector may also include other types of circuits that measure the voltage and current at the ports.

Electromagnetic waves in the energy application zone may exhibit a certain field pattern. A “field pattern” may refer to an electromagnetic field configuration characterized by, for example, the amplitude of electric field intensity distribution in the energy application zone. In general, electromagnetic field intensity may be time varying and spatially dependent. That is, not only may the field intensity differ at different spatial locations, but for a given location in space, the field intensity can vary in time or may oscillate, often in a sinusoidal fashion. Therefore, at different spatial locations, the field intensities may not reach their maximum values (i.e., their maximum amplitude values) at the same time. Because the field intensity amplitude at a given location can reveal information regarding the electromagnetic field, such as electromagnetic power density and energy application capability, the field pattern referred to herein may include a profile representing the amplitude of field intensity at one or more spatial locations. Such a field intensity amplitude profile may be the same as or different from a snapshot of the instant field intensity distribution at a given time in the zone. As used herein, the term “amplitude” is interchangeable with “magnitude.” A resonant frequency that forms a standing wave in the energy application zone may have a field pattern having substantially constant field intensities over time in different spatial locations. For example, the absolute field intensity maxima (also known as “hot spots”) may be formed by standing wave in cavity 20.

A field pattern may be excited by applying electromagnetic energy to the energy application zone. As used herein, the term “excited” is interchangeable with “generated,” “created,” and “applied.” In general, a field pattern in an energy application zone may be uneven (i.e., non-uniform). That is, the field pattern may include areas with relatively high amplitudes of field intensity and other areas with relatively low amplitudes of field intensity. The rate of energy application may depend upon the amplitude of field intensity. For example, energy application may occur faster at areas with higher amplitude of field intensity than in areas with lower amplitude of field intensity. As used herein, the term “energy application” is interchangeable with “energy delivery.”

The apparatus of FIG. 1 may be configured to control a distribution and intensity of high amplitude electromagnetic field and low amplitude electromagnetic field in the energy application zone (maxima and minima), thus delivering differing target amounts of energy to any two (or more) given regions in the application zone. The energy application may be a modal cavity. As used herein, a “modal cavity” refers to a cavity that satisfies a “modal condition.” Modal condition refers to the relationship between the largest resonant wavelength supported by the energy application zone and the wavelength of the applied electromagnetic energy supplied by the source. In some embodiments, if the wavelength of the applied electromagnetic energy supplied by the source is greater than about one quarter of the largest resonant wavelength supported by the energy application zone, the modal condition is met. In other embodiments, a different relationship between the wavelength of the applied electromagnetic energy supplied by the source and the largest resonant wavelength supported by the energy application zone may be applied in order to meet the modal condition. In some embodiments, the modal condition may be met when low order modes are excited, e.g., m×n is below 30, 40, or 50 (wherein m and n are integers representing the mode number in different axes, e.g., x and y). The control of distribution and intensity of electromagnetic field in the energy application zone can occur through the selection of “MSEs” (as described later). Choices of MSE selection may impact how energy is distributed in regions of the energy application zone. Choices of MSE selection may impact how energy is spatially and/or temporally distributed in the energy application zone. When the modal condition is not met, it may be more difficult to achieve a desired energy application distribution through the control of MSEs. While the modal condition may be used in combination with MSE control, the modal condition may also provide benefits even if not used with MSE control, and conversely, MSE control may be applied even if the modal condition is not met.

The term “modulation space” or “MS” is used to collectively refer to all the parameters that may affect a field pattern in the energy application zone and all combinations thereof. In some embodiments, the “MS” may include all possible components that may be used and their potential settings (either absolute or relative to others) and adjustable parameters associated with the components. For example, the “MS” may include a plurality of variable parameters, the number of antennas, their positioning and/or orientation (if modifiable), the useable bandwidth, a set of all useable frequencies and any combinations thereof, power settings, phases, etc. The MS may have any number of possible variable parameters, ranging between one parameter only (e.g., a one dimensional MS limited to frequency only or phase only—or other single parameter), two or more dimensions (e.g., varying frequency and amplitude together within the same MS), or many more.

Examples of energy application zone-related MSs may include the dimensions and shape of the energy application zone and the materials from which the energy application zone is constructed. Examples of energy source-related MSEs may include amplitude, frequency, and phase of energy delivery. Examples of radiating element-related MSEs may include the type, number, size, shape, configuration, orientation and placement of antenna-like structures.

Each variable parameter associated with the MS is referred to as an MS dimension. By way of example, a three dimensional modulation space may comprise frequency (F), phase (φ), and amplitude (A). That is, in such a modulation space, frequency, phase, and amplitude of the electromagnetic waves are modulated during energy delivery, while all the other parameters may be predetermined and fixed during energy delivery. An MS may also be one dimensional where only one parameter is varied during the energy delivery. An MS may also be higher-dimensional such that more than one parameter is varied.

The term “modulation space element” or “MSE” may refer to a specific set of values of the variable parameters in MS. Therefore, the MS may also be considered to be a collection of all possible MSEs. For example, two MSEs may differ one from another in the relative amplitudes of the energy being supplied to a plurality of radiating elements. For example, in the three-dimensional MS comprising frequency (F), phase (φ), and amplitude (A), one MSE may have a specific frequency F(i), a specific phase φ(i), and a specific amplitude A(i). If even one of these MSE variables change, then the new set defines another MSE. For example, (3 GHz, 30°, 12 V) and (3 GHz, 60°, 12 V) are two different MSEs, although only the phase component changes. Sequentially swept MSEs may not necessarily be related to each other. Rather, their MSE variables may differ significantly from MSE to MSE (or may be logically related). In some embodiments, the MSE variables may differ significantly from MSE to MSE, possibly with no logical relation between them, however in the aggregate, a group of working MSEs may achieve a desired energy application goal.

In some embodiments processor 30 may be configured to regulate several components simultaneously such as modulator 14 and amplifier 16 to sequentially cause the application of various MSEs (e.g., by sequentially sweeping over frequencies, phases, and amplitudes); a process known as “MSE sweeping.” MSE sweeping may be performed to any other parameters in the MS, for example, the number, location and/or orientation of antennas, the dimensions of the energy application zone, the location and number of the field adjusting elements, etc. The MSE sweeping of amplitude, frequency, and phases is discussed herein by example only, and is not intended to limit the invention to those particular parameters. Any parameter that defines the MS may be swept during “MSE sweeping.”

Differing combinations of these MS parameters may lead to differing field patterns across the energy application zone and differing field intensities distribution patterns in the object. A plurality of MSEs that may be executed sequentially or simultaneously to excite a particular field pattern in the energy application zone and may be collectively referred to as an “energy delivery scheme.” For example, an energy delivery scheme may consist of three MSEs (F(1), φ(1), A(1)), (F(2), φ(2), A(2)), (F(3), (φ(3), A(3)). Since there are a virtually infinite number of MSEs, there are a virtually infinite number of different energy delivery schemes, resulting in virtually infinite number of differing field patterns in any given energy application zone (although different MSEs may at times cause highly similar or even identical field patterns). Of course, the number of differing energy deliver schemes may be, in part, a function of the number of MSEs that are available. The invention, in its broadest sense, is not limited to any particular number of MSEs or MSE combinations. Rather, the number of options that may be employed could be as few as two or as many as the designer desires, depending, for example, on factors such as intended use, level of desired control, hardware or software resolution and cost.

An apparatus or method of the invention may involve the use of a processor, for example processor 30, as illustrated in FIG. 1. As used herein, the term “processor” may include an electric circuit that executes one or more instructions. For example, such a processor may include one or more integrated circuits, microchips, microcontrollers, microprocessors, all or part of a central processing unit (CPU), graphics processing unit (GPU), digital signal processors (DSP), field-programmable gate array (FPGA) or other circuit suitable for executing instructions or performing logic operations.

The instructions executed by the processor may, for example, be pre-loaded into the processor or may be stored in a separate memory unit such as a RAM, a ROM, a hard disk, an optical disk, a magnetic medium, a flash memory, other permanent, fixed, or volatile memory, or any other mechanism capable of providing instructions to the processor. The processor(s) may be customized for a particular use, or can be configured for general-purpose use and perform different functions by executing different software.

If more than one processor is employed, all may be of similar construction, or they may be of differing constructions electrically connected or disconnected from each other. They may be separate circuits or integrated in a single circuit. When more than one processor is used, they may be configured to operate independently or collaboratively. They may be coupled electrically, magnetically, optically, acoustically, mechanically, wirelessly or in any other way permitting at least one signal to be communicated between them.

A single or multiple processors may be provided for the sole purpose of regulating the source. Alternatively, a single or multiple processors may be provided with the function of regulating the source in addition to providing other functions. For example, the same processor(s) used to regulate the source may also be integrated into a control circuit that provides additional control functions to components other than the source.

In accordance with some embodiments of the invention, at least one processor, e.g., processor 30, may be configured to regulate the source in order to apply a first predetermined amount of energy to a first predetermined region and a second predetermined amount of energy to a second predetermined region in the energy application zone, wherein the first predetermined amount of energy is different from the second predetermined amount of energy. For example, field patterns may be selected having known areas with high amplitude of electromagnetic field intensity (hot spots). Thus, by aligning a hot spot with a region in an energy application zone, a predetermined field pattern may be chosen to apply a first predetermined amount of energy to a first predetermined region. When another field pattern is chosen having a differing hot spot, that second field pattern may result in application of a second predetermined amount of energy to a second predetermined region. In fact, energy application may occur in all non-zero intensities that coincide with the object, and the extent of heating may depend, among other things, on the intensity of the field to which the object is exposed and the duration of exposure. Differing MSEs and/or combinations of MSEs may be chosen in order to apply differing or similar predetermined amounts of energy to differing predetermined regions (e.g., to obtain uniform heating). In either instance, control of the amount of energy applied may be achieved through either the processor's selection of particular field patterns or MSEs, and/or control of, for example, power level, a duration of time that power is applied during a particular condition, or combinations of the above. The processor may make such selections in order to achieve a desired energy deliver scheme.

The term “region” may include any portion of an energy application zone, such as a cell, sub-volume, sub-division, discrete sub-space, or any sub-set of the energy application zone, regardless of how that subset is discretized. The term “discretized” is interchangeable with the terms “portioned,” “partitioned,” “allocated,” or “divided.” In one particular example, the energy application zone may include two regions. In another example, the energy application zone may include more than two regions. The regions may or may not overlap with each other, and the size of each region may or may not be the same.

The at least one processor may also be configured to predetermine the locations of the two regions (i.e., first region and second region). This may occur, for example, through reflective feedback from the energy application zone, providing information about a location of an object in the zone. In other embodiments, this may be achieved through imaging. In some embodiments, the regions may correspond to different portions of the object, and differing targeted amounts of electromagnetic energy may be delivered to these different portions of the object. The amount of energy actually dissipated in each region may be depend on the field intensity at that region and the absorption characteristics of the corresponding portion of the object at that particular region. In yet other embodiments, the predetermined locations may be a function of known geometry of a field pattern without reference to an object in the energy application zone. In some embodiments, locations of the first region and the second region may also be predetermined by a user or a device other than the at least one processor.

Two regions may be located adjacent to each other in the energy application zone. For example, the energy application zone may include a region occupied by an object or a portion of an object, and another region defining an area distinct from the area of the object. In this case, these two regions may be adjacent to each other and separated by a boundary. For example, the first region may be within the cup of soup being heated, and the second region may be outside of the cup of the soup. In another example, the energy application zone may include two regions that have different energy absorption characteristics within the object. For example, the first region may contain mostly water at the top layer of the soup, and the second region may contain mostly potatoes and/or meats towards the bottom layer of the soup. Because of their differing energy absorption characteristics, it may be beneficial to excite field patterns with differing electrical field intensities at these two regions. Based on the difference in the local field intensities and the energy absorption characteristics of the two regions, the dissipated energy in each of the regions may be predetermined. Accordingly, the dissipated energy may be made substantially equal or different, as desired, across differing regions in the object, by selecting and controlling MSEs for constructing a suitable energy deliver scheme for delivering the energy.

MSE selection may impact how energy is distributed in regions of the energy application zone. In order to apply differing targeted amounts of electromagnetic energy to differing predetermined regions in the energy application zone, the processor may control one or more MSEs in order to achieve a field pattern that targets energy to a specific predetermined region in the energy application zone. The selection of MSEs that result in standing waves and may provide an added measure of control since standing waves tend to exhibit predictable and distinctly defined “high-intensity regions” (hot spots) and “low-intensity regions” (cold spots), as described earlier, where the a high-intensity region may exhibit an energy concentration that is readily distinguishable from a low-intensity region. It is to be understood that the term “cold spot” does not necessarily require a complete absence of applied energy. Rather, it may also refer to areas of diminished intensity relative to the hot spots. That is, in the high-intensity regions, the intensity of the field is higher than the intensity of the field in the low-intensity regions. Therefore, the power density in the high-intensity region is higher than the power density in the low-intensity region. The power density and field intensity of a spatial location are related to the capability of applying electromagnetic energy to an object placed in that location. And therefore, the energy application rate is higher in a high-intensity region than that in a low-intensity region. In other words, the energy application may be more effective in a high-intensity region. Thus, by controlling the high-intensity regions and/or low intensity regions in the energy application zone, the processor, e.g., processor 30, may control the energy application to a specific spatial location. Such control of high- and low-intensity regions may be achieved by controlling MSEs, for example, by controlling modulator 14 to modulate one or more of amplitude, phase, and frequency of the applied electromagnetic wave.

Controllable MSE variables may include one or more of amplitude, phase, and frequency of the applied electromagnetic wave; a location, orientation, and configuration of each radiating element; or the combination of any of these parameters, or other parameters that may affect a field pattern.

For example, as depicted in FIG. 1, an exemplary processor 30 may be electrically coupled to various components of the apparatus, such as power supply 12, modulator 14, amplifier 16, and radiating elements 18. Processor 30 may be configured to execute instructions that regulate one or more of these components. For example, processor 30 may regulate the level of power supplied by power supply 12. Processor 30 may also regulate the amplification ratio of amplifier 16, by switching, for example, the transistors in the amplifier. Alternatively or additionally, processor 30 may perform pulse-width-modulation control of amplifier 16 such that the amplifier outputs a desired waveform. Processor 30 may regulate modulations performed by modulator 14, and may alternatively or additionally regulate at least one of location, orientation, and configuration of each radiating element 18, such as through an electro-mechanical device. Such an electromechanical device may include a motor or other movable structure for rotating, pivoting, shifting, sliding or otherwise changing the orientation or location of one or more of radiating elements 18. Processor 30 may be further configured to regulate any field adjusting elements located in the energy application zone, in order to change the field pattern in the zone. For example, field adjusting elements may be located in the energy application zone and may be configured to selectively direct the electromagnetic energy from the radiating element, or to simultaneously match a radiating element acting as a transmitter to reduce coupling to the one or more other radiating elements acting as a receiver.

In another example, when a phase modulator is used, it may be controlled to perform a predetermined sequence of time delays on the AC waveform, such that the phase of the AC waveform is increased by a number of degrees (e.g., 10 degrees) for each of a series of time periods. Alternatively, the processor may dynamically and/or adaptively regulate modulation based on feedback from the energy application zone. For example, processor 30 may be configured to receive an analog or digital feedback signal from detector 40, indicating an amount of electromagnetic energy received from cavity 20, and processor 30 may dynamically determine a time delay at the phase modulator for the next time period based on the received feedback signal.

The energy distribution that results from any given combination of MSEs may be determined, for example, through testing, simulation, or analytical calculation. Using the testing approach, sensors (e.g., small antennas) may be placed in an energy application zone, to measure the energy distribution that results from a given combination of MSEs. The energy application zone may or may not comprise an object. The distribution can then be stored in, for example, a look-up table. In a simulated approach, a virtual model may be constructed so that combinations of MSEs can be tested in a virtual manner. For example, a simulation model of an energy application zone may be performed in a computer based on a set of MSEs inputted to the computer. A simulation engine such as CST or HFSS may be used to numerically calculate the field distribution inside the energy application zone. The resulting field pattern may be visualized using imaging techniques or stored in a computer as digital data. The correlation between MSE and resulting field pattern may be established in this manner. This simulated approach can occur well in advance and the known combinations stored in a look-up table, or the simulation can be conducted on an as-needed basis during an energy application operation. The simulation may be conducted on an empty energy application zone (e.g., an energy application zone not including an object) or may be conducted on an energy application zone including an object, e.g., object 50, located in the energy application zone, e.g., cavity 20.

Similarly, as an alternative to testing and simulation, calculations may be performed based on an analytical model in order to predict energy distribution based on selected combination of MSEs. For example, given the shape of an energy application zone with known dimensions, the basic field pattern corresponding to a given MSE may be calculated from analytical equations. This basic field pattern, also known as a “mode,” may then be used to construct a desired field pattern by linear combinations. As with the simulated approach, the analytical approach may occur well in advance and the known combinations stored in a look-up table, or may be conducted on an as-needed basis during an energy application operation.

In accordance with some embodiments of the invention, the processor may be configured to cause the application of predetermined amounts of energy to at least two regions in the energy application zone. The energy amount may be predetermined based on known characteristics of the object in the energy application zone. For example, in the case of a dedicated oven that repetitively heats products sharing the same physical characteristics (e.g., identical hamburger patties), the processor may be pre-programmed to cause the application of differing known amounts of energy corresponding to at least two known field patterns. The processor may cause the application of differing amounts of energy depending on the field pattern. That is, the power or duration of energy application may be varied as a function of the field pattern being applied. (i.e., resulting from an MSE). This correlation between the predetermined amounts of energy to be applied and the field pattern may be determined by testing, simulation, or analytical analysis, as discussed previously.

By way of another example, the correlation between field pattern and amount of energy delivered may be determined by the energy absorption profile of the object at issue. That is, once an object's ability to absorb energy throughout its volume is determined, energy can be applied to the object in a controlled manner in order to achieve a desired goal. For example, if the goal is to uniformly apply energy across an object's volume, then the processor might select combinations of MSEs that result in uniform energy application. If on the other hand, non-uniform energy application is desired, then the processor might cause the application of predetermined amounts of energy with each differing field pattern in order to achieve the desired non-uniformity.

In accordance with some embodiments of the invention, the processor may be configured to cause a predetermined field pattern in the energy application zone, the field pattern having at least one high-intensity region and at least one low-intensity region, and wherein the apparatus may be configured to cause the at least one high-intensity region to coincide with a location of the object in the energy application zone. The term “predetermined field pattern” may be any actual or predicted field pattern that results from an MSE. A predetermined field pattern may be an approximation of an expected field pattern, and may be obtained, for example, through calculation, simulation, or measurement with or without a load or object present in the energy application zone. During an energy application process, when there are one or more objects located in the energy application zone, the actual field pattern in the energy application zone may not be exactly the same as the predicted field pattern because the presence of object(s) may somewhat change the field pattern. However, the main characteristics of the field pattern, such as the location and field intensity of hot/cold spots may be substantially the same as predicted. Therefore, the relationship between MSE and field pattern may still be preserved, regardless of whether object(s) are present in the energy application zone.

The processor may be configured to identify field patterns having high-intensity regions corresponding to different areas in the energy application zone, and to cause the application of the field patterns in order to apply energy to the areas. In high-intensity regions, the transfer of electromagnetic energy from electromagnetic waves to an object may be more effective than that in surrounding areas, whereas the transfer of electromagnetic energy may be less effective in low-intensity regions. Such phenomena may be used to control the application of electromagnetic energy to the object. For example, the processor may cause a predetermined field pattern in the energy application zone through controlling MSEs. As a result, the location of the high-intensity regions associated with the field pattern may be known in advance. The processor may be configured to cause high-intensity regions to coincide with the location of the object. For example, in a situation where a location of the object is known in advance, the processor may select an MSE to cause a corresponding known field pattern in which at least one high-intensity region may coincide with the location of the object. When the location of the object is not known in advance, the processor may receive feedback indicative of absorbed energy in the energy application zone. That is, if at least one high-intensity region coincides with a location of the object, the amount of energy absorbed in the energy application zone may be substantially larger than the case in which the high-intensity region does not coincide with the location of the object. The processor may learn this through feedback and thereafter select an MSE, thereby identifying its corresponding field pattern, that results in greater energy absorption in the energy application zone to cause at least one high-intensity region to coincide with a location of the object.

In some embodiments, low-intensity regions may also be used to apply energy to the object. For example, when at least a portion of the object is outside reachable areas of one or more high-intensity regions, the controllable energy application may still be achievable by using one or more low-intensity regions to transfer electromagnetic energy to the object, although such transfer of energy may not be as efficient and/or as fast as using high-intensity regions. In this case, the processor may control the overlapping between the object and low-intensity regions in a similar manner to use high-intensity regions.

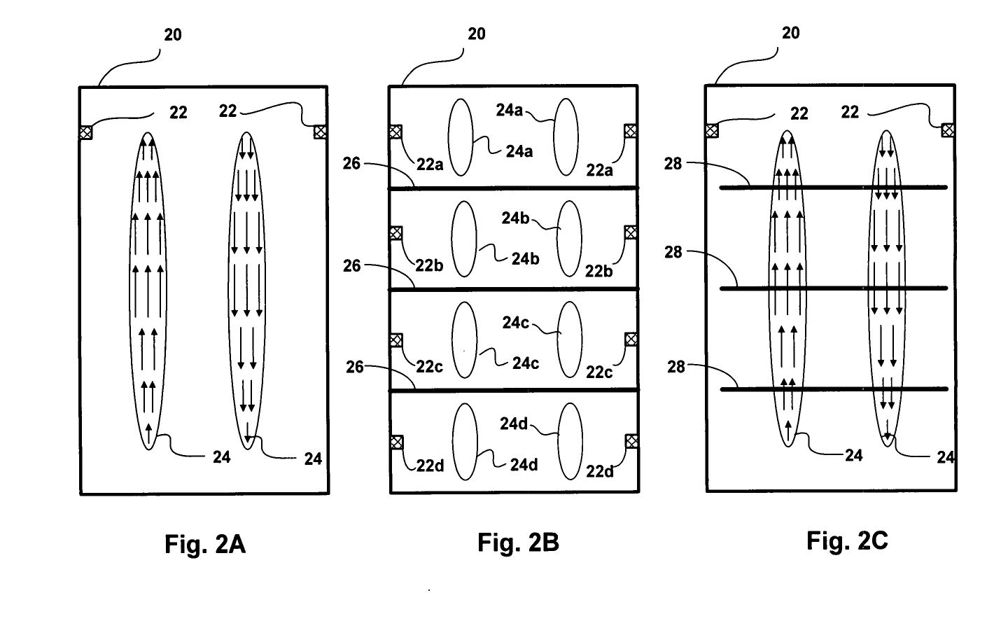

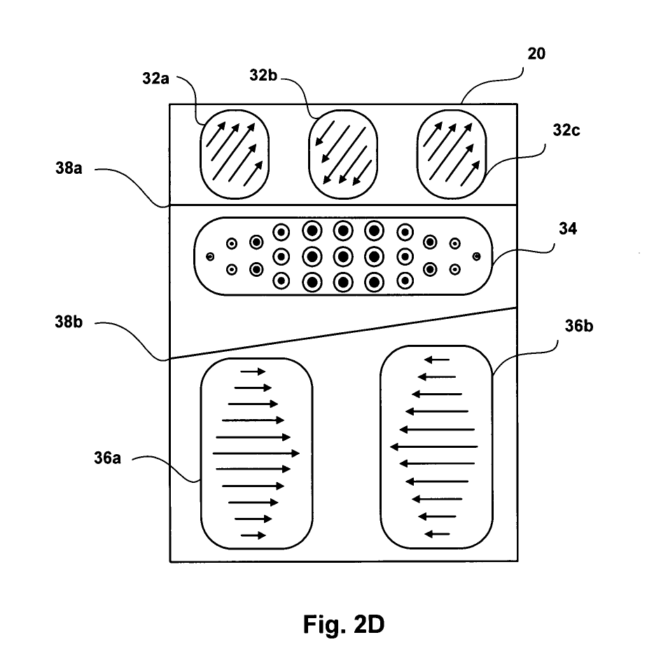

Referring to FIGS. 2A-2D, the energy application zone of cavity 20 may be dividable into subzones, in accordance with some embodiments. The term sub-zone may include any portion or portions of the energy application zone, such as a cell, sub-volume, sub-division, discrete sub-space, or any sub-portion of a cavity. In one particular example, the energy application zone may be divided into two subzones. In other examples, the energy application zone may be divided into more than two subzones. Each of the subzones may be of uniform size or, alternatively, one or more subzones may be sized differently with respect to other subzones.

At least one partition may be used to divide the energy application zone into subzones. The term partition may include any structure that divides, separates, or distinguishes the energy application zone into subzones. For example, a partition may include a physical tray, rack, frame, plate, mesh, or board placed in the energy application zone. In some embodiments, the partition may take the form of any planar component constructed to divide the energy application zone into two or more sub zones. The planar component may be substantially flat, or at least partially curved.

The partition may be constructed of an electromagnetic field disruptive material. An electromagnetic field disruptive material may include any conductive material that will potentially disrupt, disturb, change, affect, or alter an electromagnetic field. Electrical insulators, including components made from materials such as plastic, rubber, glass or polyether ether ketone (PEEK) which are transparent to the electromagnetic field, are normally not considered as electromagnetic field disruptive materials.

In accordance with some embodiments of the invention, the source may be configured to apply electromagnetic energy to multiple subzones by supplying electric fields transverse to the at least one partition. For example, FIGS. 2A-2D illustrate electric fields inside a cavity, wherein FIGS. 2B-2D illustrate cavities with multiple partitions. In FIG. 2A, cavity 20 is provided with radiating elements 22 placed inside the cavity and at the upper part of the cavity. Electromagnetic energy may be supplied by one or more sources and transmitted into the cavity through radiating elements 22. As a result, a field pattern may be generated in the cavity. For example, in FIG. 2A, a field pattern may be generated and characterized by electric field 24. It should be understood that electric field 24 are only simplified representations of the actual electric field, which is a time varying spatial vector field. Partitions may be placed inside the cavity such that electric field 24 transverses the partitions, as shown in FIG. 2B-2D. In FIG. 2B, three partitions 26 are placed inside the cavity to divide the cavity into four subzones. In FIG. 2C, three partitions 28 are placed inside the cavity to divide the cavity into four subzones. In FIG. 2D, two partitions 38a and 38b are placed inside cavity 20 to divide the cavity into three subzones. The term “transverse” may include any relation between the position of a partition, for example the plane that may be defined by the partition, and an orientation of the electric field that is not parallel to the partition, e.g., the plane defined by the partition.

The at least one partition may be configured to be electrically isolated from boundaries of the energy application zone. For example, in FIG. 2C, the three partitions 28 may be characterized as “floating” inside the cavity. That is, partitions 28 are electrically isolated from the walls that form the cavity. As a result, boundary conditions imposed on the walls of the cavity are not necessarily imposed on the partitions. Such a “floating” configuration may be achieved, for example, by using electrical insulators to provide mechanical connection but electrical isolation between the partitions and the walls of the cavity.

In some embodiments, such as the configuration represented in FIG. 2B, partitions 26 may be electrically connected to the cavity walls, thus causing the four subzones each to behave as a smaller resonator. The boundary conditions imposed on the cavity walls may be equally imposed on the partitions. Therefore, if the radiating elements are positioned only within one subzone (e.g., if only two radiating elements 22a were present in the upper subzone of the cavity in FIG. 2B—similar to the position of radiating elements 22 in FIG. 2A), an electric field 24a will be generated only in that zone and not in the remaining subzones. In order to apply electromagnetic energy in other subzones, additional radiating elements may be included. For example, referring to FIG. 2B, radiating elements 22b, 22c, and 22d may be placed in respective subzones. Using the configuration shown in FIG. 2B, the resulting electric fields 24a, 24b, 24c, and 24d can be isolated in respective subzones, and may be maintained such that these fields do not reach outside of their respective subzones. Therefore, the introduction of partitions and subzones to the cavity shown in FIG. 2B not only may change the field distribution inside the cavity, but may also require additional radiating elements in order to apply energy to all subzones. It is to be noted that field distributions in one or more of the subzones may be controlled to be different than the distributions in one or more of the other subzones. For example, in FIG. 2D, the three subzones resulting from the two partitions 38a and 38b each may have a different field distribution therein. In the upper subzone, electric fields in areas 32a, 32b, and 32c may have different orientations (directions). In areas 32a and 32c, the electric field may have components directing to the upper right direction. While in area 32b, the electric field may have components directing to the lower left direction. Even in areas 32a and 32c, the direction of the electric field may also be different. In the middle subzone, the electric field may be distributed differently from that in the upper subzone. For example, the electric field in area 34 may have components directing outside the plane of the paper (toward the reader). Alternatively, the electric field may also have components directing inside the plane of the paper (away from the reader). In some other embodiments, the direction of the electric field may be the combination of the two directions. In the lower subzone, the electric field may be distributed in yet another way. For example, in area 36a, the electric field may have components directing horizontally to the right, and in area 36b, the electric field may have components directing horizontally to the left. In this case, the electric field may still be transverse to the partition because the partition itself, such as 38b, may not reside in a horizontal plane. Again, the transverse condition is based on the relative relationship between the position of the partition and the orientation (direction) of the electric field. As long as the electric field is not parallel to the partition, the transverse condition is met.

In certain embodiments, the source may be configured to supply electric fields perpendicular (i.e. about or even exactly 90°) to the at least one partition. For example the electric field 24 shown in FIG. 2C may be supplied perpendicular to partitions 28. It should be understood that perpendicular is a special case of transverse, as the angle between the direction of the electric field and the plane of partition under transverse conditions may have any value between zero degrees and 180 degrees (not including zero and 180 degrees). The orientation of an electromagnetic field is determined mainly by the polarization, orientation, and configuration of the radiating element. The field orientation depends on cavity shape and dimensions and on other parameters associated with an electromagnetic energy application condition, such as the frequency, phase and amplitude of electromagnetic waves within the cavity. The field orientation that results from any given electromagnetic energy application condition may be determined, for example, through simulation, analytical calculation or testing. Using the testing approach, sensors (e.g., small antennas) can be placed in an energy application zone to measure the electromagnetic field orientation. The field orientation may then be stored in a look-up table, for example, or in any other suitable storage system. In a simulated approach, a virtual model may be constructed so that the field orientation corresponding to a particular electromagnetic energy application condition can be tested in a virtual manner. For example, a simulation model of an energy application zone may be performed in a computer based on a particular electromagnetic energy application condition provided as input to the computer. A simulation engine such as CST or HFSS may be used to numerically calculate the field orientation inside the energy application zone. The resulting field orientation may be visualized using imaging techniques or stored in a computer as digital data. This simulated approach may occur in advance and the known field orientations may be stored in a look-up table. Alternatively or additionally, the simulation may be conducted on an as-needed basis during an energy application operation.

Similarly, as an alternative to testing and simulation, calculations may be performed based on an analytical model in order to predict field orientations. For example, with an energy application zone of known shape and dimensions, the basic field orientations corresponding to a particular electromagnetic energy application condition may be calculated from analytical equations. As with the simulated approach, the analytical approach may occur in advance, and the known field orientations may be stored in a look-up table, or may be conducted on an as-needed basis during an energy application operation.

When the source is configured to supply an electric field, which is perpendicular to the partition(s), the electric field may not be disturbed or altered, even if the partition(s) is made of an electromagnetic field disruptive material (e.g., electric field 24 in FIG. 2C, if perpendicular to partitions 28). In other words, in case of a perpendicular or transverse field, the partitions 28 are transparent or invisible to the electric field 24. As a result, although cavity 20 is physically divided into four subzones by partitions 28, the cavity may be electrically seen as having only one zone. Therefore, the presence of partitions may not disturb the electric field distribution inside the cavity. As a result, additional radiating elements may not be required in order to apply energy simultaneously to more than one subzone.

In accordance with some embodiments of the invention, the at least one partition may include a metal tray. For example, in the application of a commercial thermal oven, metal trays are routinely used to heat multiple layers of objects (such as food) simultaneously. In electromagnetic wave based ovens, however, such metal trays may disturb an electric field condition associated with the electromagnetic waves because the trays are often slid into the oven via tracks on the oven walls. As discussed previously, dividing subzones in this manner can create smaller resonators and may separate the resulting subzones both physically and electrically. As a result, more radiating elements may be needed to supply electromagnetic energy to the isolated subzones. The presently disclosed system, however, may obviate the need for additional radiating elements by essentially floating the metal trays inside the cavity, so as to divide the cavity into subzones physically but not electrically. In view of the electrical isolation of the dividers from the walls of the cavity, no additional radiating elements may be needed to achieve simultaneous heating of the subzones created by the dividers (e.g., partitions). In some embodiments, the subzones may be heated simultaneously in a uniform manner or substantial uniform manner (e.g., a substantial identical distribution of the electromagnetic field may be created in each subzone). In other embodiments, the subzones may be heated simultaneously in a non-uniform manner (e.g., a different distribution of the electromagnetic field may be created in each subzone).

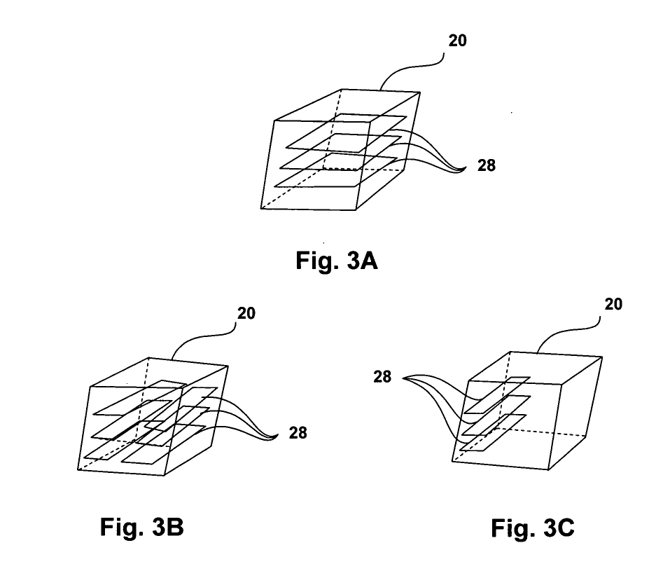

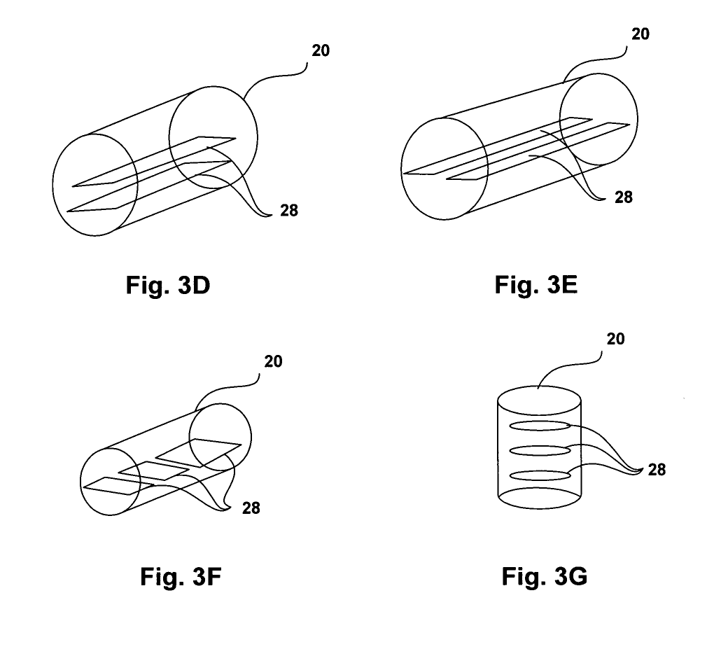

In some embodiments, the at least one partition may include a slatted structure. For example, as illustrated in FIGS. 3B, 3E, and 3F, partitions 28 may be configured to include multiple sections located within a common horizontal plane. Such a configuration may be advantageous when, for example, cavity 20 has a relatively large horizontal dimension. The slatted structure may include a grill (meshed tray).

The at least one partition may also be sized to partially divide the energy application zone into subzones. For example, as shown in FIG. 3C, three partitions 28 are placed on the left side of cavity 20 and sized to only partially divide the cavity. Such a configuration may be advantageous when, for example, cavity 20 is configured for heating both small sized objects and one or more large sized objects in close succession or, for example, at the same time.

Cavity 20 and partitions 28 may be arranged in any suitable manner depending, for example, on the requirements of a particular application. For example, FIGS. 3A-3G provide diagrammatic representations of various cavity and partition configurations consistent with the presently disclosed embodiments. It should be noted that other cavity and partition configurations beyond those shown may be implemented without departing from the scope of the present invention.

FIG. 3A represents a rectangular cavity 20 having multiple layers of partitions 28. In FIG. 3B, slatted partitions 28 are illustrated in a rectangular cavity 20. FIG. 3C represents a rectangular cavity 20 partially divided by partitions 28. FIG. 3D shows a cylindrical cavity 20 with multiple layers of partitions 28. FIG. 3E shows a cylindrical cavity 20 having slatted partitions 28 arranged within a horizontal plane such that the major dimension of the partitions extends in parallel to the longitudinal axis (or major dimension) of cavity 20. FIG. 3F shows another cylindrical cavity 20 having slatted partitions 28 arranged such that a minor dimension of the partitions extends in parallel to the longitudinal axis (or major dimension) of cavity 20. FIG. 3G shows a vertically oriented cylindrical cavity 20 including multiple layers of partitions 28. As previously noted, the present invention is not limited to the particular configurations represented by FIGS. 3A to 3G. Rather, any suitable arrangement of a cavity 20 and partitions 28 may be employed, including, for example, any permutation of the cavities and partitions shown in FIGS. 3A to 3G.

The partition may comprise more than one material. In some embodiments, the partition may comprise an electric field disruptive (e.g., conductive) material and an electric field non-disruptive material. For example, the partition may comprise a metal tray placed atop a glass shelf, a ceramic base, a plastic tray, or any other suitable combination of materials.

Various examples of the invention are described herein in connection with partitioned cavities. Persons of ordinary skill in the art will appreciate that core; inventive principles of energy application discussed herein may be applied across various forms of energy application zones, and for a variety of purposes other than or including heating.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment of the invention.

Moreover, it will be apparent to those skilled in the art from consideration of the specification and practice of the present disclosure that various modifications and variations can be made to the disclosed systems and methods without departing from the scope of the invention, as claimed. Thus, it is intended that the specification and examples be considered as exemplary only, with a true scope of the present disclosure being indicated by the following claims and their equivalents.

What is claimed is:

1. An apparatus for applying electromagnetic energy to an object, comprising:
a source of electromagnetic energy; and
an energy application zone divided into subzones by at least one partition;
wherein the at least one partition comprises an electromagnetic field disruptive material and is electrically isolated from boundaries of the energy application zone; and
wherein the source is configured to apply electromagnetic energy to more than one of the subzones by supplying electric fields transverse to the at least one partition.

2. The apparatus of claim 1, wherein the source is configured to supply electric fields perpendicular to the at least one partition.

3. The apparatus of claim 1, wherein the at least one partition includes a metal tray.

4. The apparatus of claim 1, wherein the at least one partition includes a slatted structure.

5. The apparatus of claim 1, wherein the at least one partition is configured to only partially divide the energy application zone into subzones.

6. The apparatus of claim 1, wherein the boundaries of the energy application zone include walls of a cavity, and one or more electrical insulators electrically isolate the at least one partition from the walls.

7. An apparatus for applying electromagnetic energy to an object, comprising:
an energy application zone divided into subzones by at least one partition comprising an electromagnetic field disruptive material;
a source of electromagnetic energy;
at least one radiating element in communication with the source of electromagnetic energy and configured to supply electromagnetic energy into the energy application zone; and
at least one processor configured to regulate the source in order to apply a first predetermined amount of energy to a first predetermined region in the energy application zone and a second predetermined amount of energy to a second predetermined region in the energy application zone, wherein the first predetermined amount of energy is different from the second predetermined amount of energy.

8. The apparatus of claim 7, wherein the regulating includes causing a predetermined field pattern in the energy application zone, the field pattern having at least one high-intensity region and at least one low-intensity region, wherein field intensities associated with high-intensity regions are higher than field intensities associated with low-intensity regions, and wherein regulating further includes causing the at least one high-intensity region to coincide with a location of the object in the energy application zone.

9. The apparatus of claim 8, wherein the regulating includes causing a plurality of field patterns, and wherein the processor is further configured to:
identify a first field pattern having a first high-intensity region corresponding to a first area of the energy application zone;
identify a second field pattern having a second high-intensity region corresponding to a second area of the energy application zone, wherein the first area is different from the second area and wherein the first area and the second area at least partially overlap at least a portion of the object; and
control the source to apply the first field pattern and the second field pattern in order to apply energy to the first area and the second area.

10. The apparatus of claim 7, wherein the at least one partition includes a metal tray.

11. The apparatus of claim 7, wherein the at least one partition includes a slatted structure.

12. The apparatus of claim 7, wherein the at least one partition is configured to only partially divide the energy application zone into subzones.

13. The apparatus of claim 7, wherein the at least one partition is electrically isolated from boundaries of the energy application zone.

14. The apparatus of claim 7, wherein the source is configured to apply electromagnetic energy to more than one of the subzones by supplying electric fields transverse to the at least one partition.

15. The apparatus of claim 7, wherein the source is configured to supply electric fields perpendicular to the at least one partition.

16. The apparatus of claim 7, wherein the boundaries of the energy application zone include walls of a cavity, and one or more electrical insulators electrically isolate the at least one partition from the walls.

17. The apparatus of claim 7, wherein the energy application zone resides within a cavity and wherein the energy application zone is divided into subzones by at least one partition constructed of an electromagnetic field disruptive material.

18. The apparatus of claim 13, wherein the boundaries of the energy application zone include walls of a cavity, and one or more electrical insulators electrically isolate the at least one partition from the walls.

19. A method for applying electromagnetic energy from a source to an object in an energy application zone, comprising:
dividing the energy application zone into subzones using at least one partition, wherein the at least one partition comprises an electromagnetic field disruptive material and is electrically isolated from boundaries of the energy application zone; and
applying electromagnetic energy to more than one of the subzones by supplying electric fields transverse to the at least one partition.

20. The method of claim 19, wherein the supplying further includes supplying the electric fields perpendicular to the at least one partition.

21. An apparatus comprising a source of electromagnetic energy for applying electromagnetic energy to an object, the apparatus comprising:
an energy application zone divided into subzones by at least one partition,
wherein the at least one partition comprises an electromagnetic field disruptive material and is electrically isolated from boundaries of the energy application zone; and
wherein the source is configured to apply electromagnetic energy to more than one of the subzones by supplying electric fields transverse to the at least one partition.
